(19) United States
(12) Patent Application Publication
(10) Pub. No.: US 2019/0077254 A1
(43) Pub. Date: Mar. 14, 2019

(54) RENEWABLE ENERGY POWERING SYSTEM

(71) Applicant: Robert E. Stanley, II, Chico, CA (US)

(72) Inventor: Robert E. Stanley, II, Chico, CA (US)

(21) Appl. No.: 15/702,623

(22) Filed: Sep. 12, 2017

(51) Int. Cl. B60K 16/00; B60K 6/10; B60K 6/28

(52) U.S. Cl. CPC B60K 16/00; B60K 2016/003; B60K 6/28; B60K 6/10

(57) ABSTRACT

An alternative energy system utilizes a combination of renewable energy components creating a synergy for generating electricity to power a large vehicle. The renewable energy components include, a primary solar panel, a transparent solar panel, and a brake apparatus. The primary solar panel and the transparent solar panel substantially cover the surface area of a vehicle. The primary solar panel and the transparent solar panel have an ultrathin configuration to enable enhanced resiliency, and to at least partially wrap around a substantial portion of the surface area of the vehicle, including the windows. The brake apparatus includes a regenerative brake that converts kinetic energy of the moving vehicle to electricity when the brakes are applied. The generated electricity is carried to an electricity storage device that selectively powers an electric motor. The system is effective with large vehicles that have spacious surface area and large kinetic energy when braking.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a renewable energy powering system. More particularly, certain embodiments of the invention relate to a powering system that powers an electric motor in a vehicle with a combination of a primary solar panel that substantially covers the vehicle while regenerating power for the electric motor from solar energy, a transparent solar panel that substantially covers the windows of the vehicle while regenerating power for the electric motor from solar energy, and a brake apparatus that converts kinetic energy generated by the vehicle into power for the electric motor.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that renewable energy is energy that is collected from resources which are naturally replenished on a human timescale, such as sunlight, wind, rain, tides, waves, and geothermal heat.

Typically, solar energy, radiant light and heat from the sun, is harnessed using a range of ever-evolving technologies such as solar heating, photovoltaics, concentrated solar power (CSP), concentrator photovoltaics (CPV), solar architecture and artificial photosynthesis. Such a photovoltaic system generally converts light into electrical direct current by taking advantage of the photoelectric effect.

It is known that because of diminishing fossil fuel supplies, alternate sources of energy have been investigated for possible use in powering vehicles, such as automobiles, trucks, buses, and rail vehicles. Alternate sources of energy also have been investigated as a means for reducing pollutant levels, a major portion of which is emitted from the use of petroleum derived fuels, such as gasoline and diesel fuel used in vehicles.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side view of an exemplary renewable energy powering system operatively joined with at least one power source and an electric motor of a vehicle, in accordance with an embodiment of the present invention;

FIG. 2 illustrates a side view of an exemplary electricity storage device operatively joined with a renewable energy powering system at a front end of a vehicle, in accordance with an embodiment of the present invention;

FIG. 3 illustrates a side view of an exemplary power source operatively joined with a renewable energy powering system at a rear end of a vehicle, in accordance with an embodiment of the present invention;

FIG. 4 illustrates a side view of an exemplary transparent solar panel joined with a window in a vehicle and operatively joined with a power source, in accordance with an embodiment of the present invention; and

FIG. 5 illustrates a side view of an exemplary transparent solar panel joined with a window in a vehicle and operatively joined with a power source, in accordance with an embodiment of the present invention

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C . . . sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of vehicles that generate power from renewable energy that may be provided by preferred embodiments of the present invention. In one embodiment of the present invention, a renewable energy powering system may help power a vehicle through renewable energy sources by covering a substantial portion, or surface area of the vehicle with a primary solar panel and a transparent solar panel and harnessing the kinetic motion of the vehicle, so as to regenerate both solar energy and kinetic energy into power for at least partial operation of the vehicle, and especially a large vehicle.

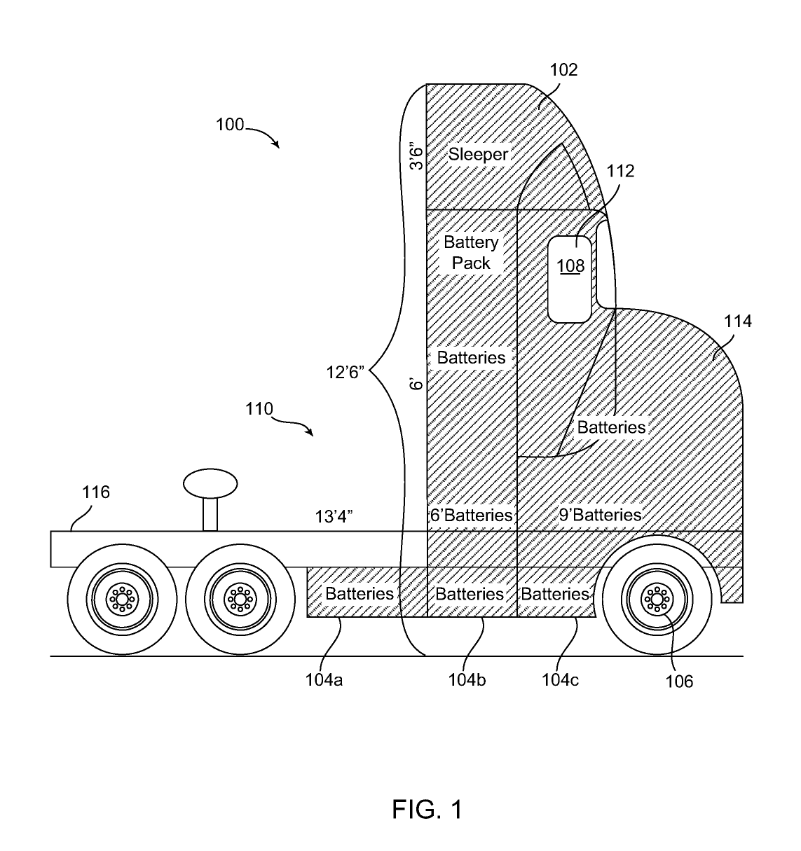

FIG. 1 illustrates a side view of an exemplary renewable energy powering system 100 operatively joined with a vehicle 110, in accordance with an embodiment of the present invention. In one aspect, the renewable energy powering system 100 may utilize a combination of renewable energy components that create a synergy where the whole is greater than the parts for generating power. The renewable energy components may include, without limitation, a primary solar panel 102 and a transparent solar panel 108, and brake apparatus 106. The solar panels 102 and brake apparatus 106 are operatively joined with at least one electricity storage device 104a, 104b, 104c that receives and stores the generated electricity, and an electric motor (not shown) that selectively receives the stored electricity from the electricity storage device for at least partially powering the vehicle 110.

In some embodiments, the renewable energy powering system may include a primary solar panel 102 and a transparent solar panel 108 that are configured to substantially cover the surface area of the vehicle 110. In some embodiments, the primary solar panel 102 and the transparent solar panel 108 may have a thin configuration to enable enhanced resiliency. This resiliency enables the primary solar panel 102 and the transparent solar panel 108 to at least partially wrap around a substantial portion of the surface area of the vehicle 110, including the windows. The primary solar panel 102 may fit into tiny crevices and follow the contour of depressions, curves, and protrusions that form on the surface of the vehicle 110. The primary solar panel 102 may also have an ultrathin configuration that forms a low profile, so as to minimize air friction as the vehicle 110 moves. Thus, by being resilient enough to substantially cover the surface area of the vehicle 110, the primary solar panel 102 and the transparent solar panel 108 may optimize generation of electricity.

In some embodiments, the primary solar panel 102 and the transparent solar panel 108 may be configured to substantially cover the surface area of the vehicle 110 while regenerating power for the electric motor from solar energy. The surface area of the vehicle 110 may include, without limitation, a front cab 114 of a semi-trailer or tractor-truck, a trailer 116 of a semi-trailer or tractor-truck, a roof of a semi-trailer or bus, and a sidewall of a semi-trailer or bus. These components of vehicles 110 are generally large and have extensive surface areas. For example, without limitation, the front cab may be 12 feet 6 inches high, and may be 13 feet four inches long and the trailer maybe 20 feet to 80 feet long. (FIG. 1).

In other embodiments, the transparent solar panel 102 may substantially cover at least one window 112a-f of the vehicle 110 while at least partially regenerating power for the electric motor from solar energy. The transparent solar panel 102 enables at least one-way visibility through the window.

In one embodiment, the primary solar panel 102 and the transparent solar panel 108 may be configured to form a resilient solar skin that can press against the surface area of the vehicle 110. The solar skin has an ultrathin configuration. The solar skin may be painted on the vehicle 110 or adhered to the surface area of the vehicle 110. Despite its ultrathin configuration, the solar skin utilizes photovoltaic principles for generation of electricity, as discussed below.

As FIG. 1 illustrates, the primary solar panel 102 and the transparent solar panel 108 may substantially cover the surface area of a semi-truck or other large vehicle. The system 100 may be operatively connected to any vehicle 110 or mode of transportation known in the art. However, those skilled in the art will recognize that the present disclosure utilizes the primary solar panel 102 and the transparent solar panel 108 that substantially cover, or wrap around the vehicle 110. Thus it may be advantageous to operate the system 100 with a larger vehicle 110 known in the art, so as to optimize the more spacious surface area of the large vehicle 110. The large vehicle 110 may include, without limitation, a semi-truck, a tractor-trailer, a tanker truck, a bus, a motor coach, a motorhome, a box van truck, a refrigerated box truck, a boat, a railcar, and a plane.

In one embodiment, the primary solar panel 102 and the transparent solar panel 108 may include a plurality of photovoltaic cells to generate the electricity from the sunlight. However, in other embodiments, the primary solar panel 102 and the transparent solar panel 108 may utilize a range of evolving solar energy technologies, including, without limitation, solar heating, photovoltaics, concentrated solar power (CSP), concentrator photovoltaics (CPV), solar architecture and artificial photosynthesis,

In some embodiments, the primary solar panel 102 may be operatively joined with the rooftop surface of the vehicle 110, and a trailer attached to the vehicle. It is known in the art that a roof surface of a typical vehicle 110, i.e., automobile somewhat limits the generation of significant solar energy, the rooftop surfaces of a semi-truck and its trailer, or a long bus provide ample surface to generate significant electrical energy to augment the power needs of a heavy-duty vehicle 110, thus reducing its fuel consumption. Furthermore, the primary solar panel 102 and the transparent solar panel 108 can provide power for refrigerated trailers when parked, further reducing fuel usage.

Once joined with the surface area of the vehicle 110, the primary solar panel 102 and the transparent solar panel 108 may utilize a photovoltaic mechanism to convert solar energy from the sun to electricity, which power an electric motor of the vehicle 110. Those skilled in the art will recognize that the conversion of sunlight into electricity requires the primary solar panel 102 and the transparent solar panel 108 to be fabricated from semiconducting materials that exhibit the photovoltaic effect. The photovoltaic effect allows the semiconducting materials of the primary solar panel 102 and the transparent solar panel 108 to produce electrons, photoelectrons, or other free carriers when light from the sun is shone onto the solar panel 102 and the transparent solar panel 108. This is followed by an electrochemical process where crystallized atoms, ionized in a series, generate an electric current.

In yet other embodiments, the system 100 utilizes another form of energy to generate electricity for at least partial operation of the vehicle 110. The system 100 may include a brake apparatus 106 that may be configured to convert kinetic energy generated from motion of the vehicle 110 into power for the electric motor. In one embodiment, the brake apparatus 106 is a regenerative brake. The regenerative brake may be operatively attached to each wheel of the vehicle 110, so as to generate the optimal amount of electricity for powering the vehicle 110. It is significant to note that a large vehicle 110, such as a semi-truck or bus may generate greater amounts of kinetic energy, and thus produce more electricity when the regenerative brakes are applied than a smaller, lighter vehicle 110.

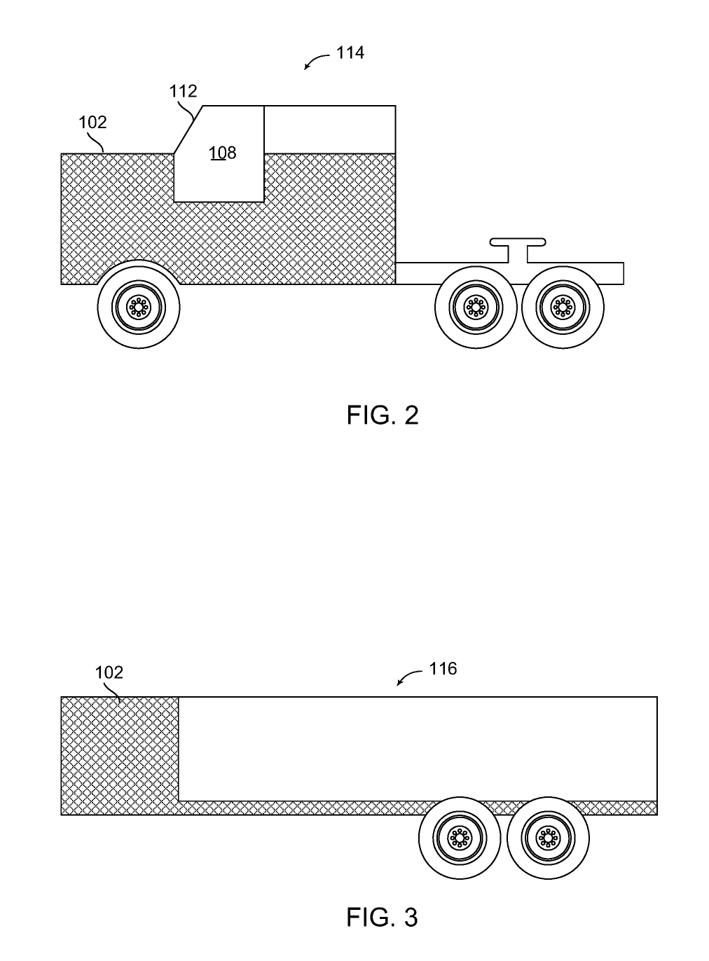

FIG. 2 illustrates a side view of an exemplary electricity storage device operatively joined with a renewable energy powering system at a front end of a vehicle 110, in accordance with an embodiment of the present invention. In one aspect, the system 110 may further include at least one power storage device 104a, 104b, 104c that powers a motor and other operational components of the vehicle 110. The power storage device 104a, 104b, 104c is operational joined with the primary solar panel 102 and the transparent solar panel 108, so as to receive the generated electricity therefrom. The photovoltaic system of the solar panels convert the sunlight into electrical direct current. The direct current is easily stored for subsequent use of powering the vehicle 110.

In some embodiments, a controller (not shown) may be used to direct the collected electrical energy from the solar panels to any of the electricity storage devices 104a, 104b, 104c that require a charge. And if, for example, a semi-trailer's refrigeration system or other auxiliary component of the vehicle 110 is running, it draws its electricity from the electricity storage device 104a, 104b, 104c.

In one embodiment, the electricity storage device 104a, 104b, 104c is disposed where a regular combustion engine in a semi-trailer or bus may normally be positioned, and where a fuel tank may normally be positioned. In another embodiemnt, the electricity storage device 104a, 104b, 104c may be disposed behind the cab of a semi-trailer by about 6 feet. In this configuration, the first 6 to 8 feet of the trailer or the floor of the trailer would support multiple electricity storage devices 104a, 104b, 104c. In another embodiment, a bus may have multiple electricity storage devices 104a, 104b, 104c in the luggage compartment just in front of the rear wheels.

In another embodiment, the electricity storage device stops at a station to plug into a fast charge outlet that recharges using 220 v or 440 v or 660 v. This may allow it to take on an 80% charge in 15 minutes. In one embodiment, the primary solar panel 102, the transparent panel 108, and the brake apparatus 106 generate sufficient electricity in a short period. This too may allow an 80% recharge in 15 minutes. The power storage is a battery or a capacitor or a rechargeable battery or any combination thereof where electrical energy is stored.

The electricity storage device 104a, 104b, 104c may operatively join with an electric motor that powers motion of the vehicle 110. The electric motor may also power auxiliary components of the vehicle 110. In one embodiment, the electric motor is a 400 horsepower Wrightspeed™ electric motor. Though in other embodiments, any electric motor that can power a large vehicle 110, such as a semi-trailer or bus, may be used.

FIG. 3 illustrates a side view of an exemplary power source operatively joined with a renewable energy powering system at a rear end of a vehicle 110, in accordance with an embodiment of the present invention. In one aspect, the surface area of the large vehicle 110 optimizes conversion of solar energy to electricity. When a trailer or other large appendix attaches to the vehicle 110, the surface area for the solar panel increases dramatically. This may be equivalent to the wings of an airplane. The primary solar panels may cover, not only the fuselage of the airplane, but the extended wings, which may double the space. As FIG. 3 illustrates, the roof and the sidewalls of the trailer may be covered with the primary solar panel 102.

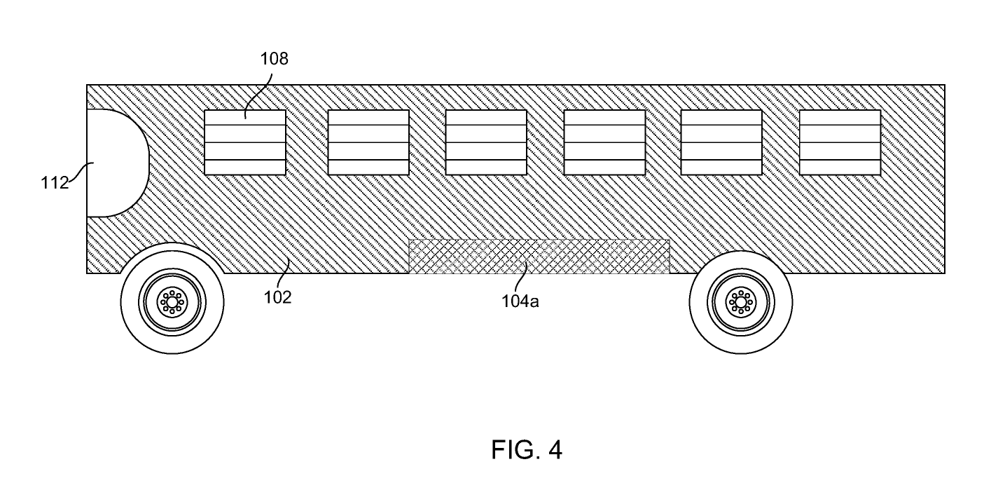

FIG. 4 illustrates a side view of an exemplary transparent solar panel 108 joined with a window in a vehicle and operatively joined with a power source, in accordance with an embodiment of the present invention. In one aspect, the transparent solar panel 108 is configured to substantially wrap at least one window in the vehicle 110. The transparent solar panel 108 may not cover the same amount of surface area as the primary solar panel 102. But the transparent solar panel 108 operates in substantially the same way, generating electricity from sunlight, and transmitting the electricity to the electricity storage device 104a, 104b, 104c. The transparent solar panel 108 may enable at least one-way visibility through the window. FIG. 4 illustrates a bus having five windows on each side, a front windshield, and a rear window; with each window carrying a transparent solar panel 108.

In operation, when the vehicle 110 is parked with all engines off, the primary solar panel 102 and the transparent solar panel 108 convert available solar energy and charge the electricity storage device of the vehicle 110. When driving the vehicle 110, the electricity storage device and, during sunlight, the primary solar panel 102 and the transparent solar panel 108 from the vehicle 110 provide power to all vehicle systems. When the electricity storage device requires charging, the primary solar panel 102 and the transparent solar panel 108 are automatically actuated and charge the electricity storage device 104a, 104b, 104c.

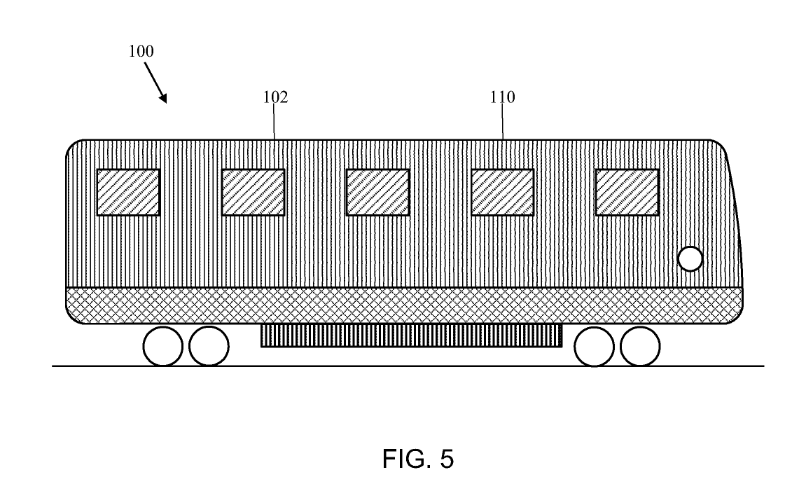

FIG. 5 illustrates a side view of an exemplary solar panel 102 joined with a window in a vehicle 110 and operatively joined with a power source, in accordance with an embodiment of the present invention. The panel 102 comprises a solar skin covering a passenger railcar or non-passenger rail car that is either self-powered or pushed and/or pulled by at least one locomotive or other means.

A thin transparent solar skin window or solar embedded window is provided as well as regenerative brakes. A quick plug-in recharge is provided. The recharge may be completed in fifteen minutes at a station using 440 or 660 volts. Batteries are stored beneath a floor. When self-powered, at least one Wrightspeed electric engine may be situated in the railcar. The railcar is manufactured with as much carbon fiber as possible. When pulled and/or pushed by the at least one locomotive, the at least one locomotive would include a large electric motor.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a renewable energy powering system that regenerates solar energy and kinetic energy into power for a vehicle according to the present invention will be apparent to those skilled in the art. Various aspects of the invention have been described above by way of illustration, and the specific embodiments disclosed are not intended to limit the invention to the particular forms disclosed. The particular implementation of the renewable energy powering system that regenerates solar energy and kinetic energy into power for a vehicle may vary depending upon the particular context or application. By way of example, and not limitation, the renewable energy powering system that regenerates solar energy and kinetic energy into power for a vehicle described in the foregoing were principally directed to renewable energy powering system that regenerates solar energy and kinetic energy into power for a vehicle implementations; however, similar techniques may instead be applied to a renewable energy powering system that powers an electric motor in a vehicle with a combination of a primary solar panel, a transparent solar panel, and a brake apparatus that converts kinetic energy generated by the vehicle into power for the electric motor, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
a primary solar panel, said primary solar panel being configured to at least partially convert light to electricity, said primary solar panel further being configured to be resilient, said primary solar panel further being configured to enable at least partial wrapping around a surface area of a vehicle;
a transparent solar panel, said transparent solar panel being configured to at least partially convert light to electricity, said transparent solar panel further being configured to be at least partially transparent, said primary solar panel further being configured to enable joining with a window of said vehicle;
a brake apparatus, said brake apparatus being configured to at least partially convert kinetic energy to electricity, whereby said kinetic energy is at least partially generated by enabling motion of said vehicle;
at least one electricity storage device, said at least one electricity storage device being configured to operatively join with said primary solar panel, said transparent solar panel, and said brake apparatus, said at least one electricity storage device further being configured to receive and store said electricity generated by said primary solar panel, said transparent solar panel, and said brake apparatus; and
an electric motor, said electric motor being configured to operatively join with said at least one electricity storage device, said electric motor further being configured to selectively receive said electricity from said at least one electricity storage device, said electric motor being further configured to enable at least partial powering of said vehicle with said electricity.

2. The system of claim 1, in which said primary solar panel comprises a photovoltaic module.

3. The system of claim 2, in which said primary solar panel comprises an ultrathin configuration.

4. The system of claim 3, in which said primary solar panel is configured to wrap around a substantial surface area of said vehicle.

5. The system of claim 4, in which said transparent solar panel comprises a photovoltaic module.

6. The system of claim 5, in which said transparent solar panel comprises an ultrathin configuration.

7. The system of claim 6, in which said transparent solar panel is configured to adhere to said window.

8. The system of claim 7, in which said brake apparatus comprises a regenerative brake.

9. The system of claim 8, wherein said regenerative brake is configured to operatively join with a plurality of wheels on said vehicle.

10. The system of claim 9, in which said at least one electricity storage device includes at least one member selected from the group consisting of: a battery, a capacitor, a rechargeable battery.

11. The system of claim 10, in which said at least one electricity storage device is disposed to position proximal to a space vacated by a fuel tank and a combustion engine.

12. The system of claim 11, in which said at least one electricity storage device is configured to be recharged at least eighty percent in about fifteen minutes.

13. The system of claim 12, in which said electric motor comprises about four hundred horsepower.

14. The system of claim 13, in which said electric motor comprises a Wrightspeed motor.

15. The system of claim 14, in which said vehicle comprises a cab and a trailer, said cab and said trailer being configured to operatively join with said primary solar panel.

16. The system of claim 15, in which said vehicle includes at least one member selected from the group consisting of: a semi-truck, a tractor-trailer, a tanker truck, a bus, a motor coach, a motorhome, a box van truck, a refrigerated box truck, a boat, and a plane.

17. The system of claim 16, in which said electric motor comprises and open source and powers enables at least partial powering of said vehicle with said electricity by propelling said vehicle.

18. A system comprising:
means for substantially covering a propulsion means;
means for substantially covering a visual means;
means for harnessing kinetic energy;
means for generating electricity from said propulsion covering means, said visual covering means, and said kinetic energy harnessing means;
means for storing said electricity generating means; and
means for powering said propulsion means with said electricity storage means.

19. A system consisting of:
a primary solar panel, said primary solar panel being configured to at least partially convert light to electricity, said primary solar panel further being configured to be resilient, said primary solar panel further being configured to enable at least partial wrapping around a surface area of a vehicle, said primary solar panel comprising an ultrathin configuration;
a transparent solar panel, said transparent solar panel being configured to at least partially convert light to electricity, said transparent solar panel further being configured to be at least partially transparent, said primary solar panel further being configured to enable joining with a window of said vehicle, said primary solar panel comprising an ultrathin configuration;
a brake apparatus, said brake apparatus being configured to at least partially convert kinetic energy to electricity, whereby said kinetic energy is at least partially generated by enabling motion of said vehicle and harnessing said kinetic energy, said brake apparatus comprising a regenerative brake;
at least one electricity storage device, said at least one electricity storage device being configured to operatively join with said primary solar panel, said transparent solar panel, and said brake apparatus, said at least one electricity storage device further being configured to receive and store said electricity generated by said primary solar panel, said transparent solar panel, and said brake apparatus, said at least one electricity storage device including at least one member selected from the group consisting of: a battery, a capacitor, a rechargeable battery, and any combination; and
an electric motor, said electric motor being configured to operatively join with said at least one electricity storage device, said electric motor further being configured to selectively receive said electricity from said at least one electricity storage device, said electric motor being further configured to enable at least partial powering of said vehicle with said electricity, said electric motor comprising about four hundred horsepower.

20. A system comprising:
a solar skin, said solar skin being configured to at least partially convert light to electricity, said solar skin further being configured to be resilient, said solar skin further being configured to enable at least partial wrapping around a surface area of a vehicle, the vehicle comprising a railcar manufactured with a maximum quantity of carbon fiber;
one of a thin transparent solar skin window and a solar embedded window;
regenerative braking equipment;
quick plug capability enabling 80% recharge in fifteen minutes at a station using 440 or 660 volts;
batteries situated below a floor surface; and
at least one Wrightspeed electric engine when self-powered,
wherein when pushed and/or pulled by at least one locomotive, a large electric motor is situated in the at least one locomotive.
